(19) United States
(12) Patent Application Publication
(10) Pub. No.: US 2008/0225872 A1
(43) Pub. Date: Sep. 18, 2008

(54) DYNAMICALLY DEFINING QUEUES AND AGENTS IN A CONTACT CENTER

(76) Inventors: Kevin T. Collins, Roseville, CA (US); Gebran G. Chahrouri, Menlo Park, CA (US); Johnny H. Lee, San Gabriel, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/684,789

(22) Filed: Mar. 12, 2007

(51) Int. Cl. H04L 12/56

(52) U.S. Cl. 370/412; 370/465

(57) ABSTRACT

In one embodiment, an automatic call distributor apparatus is provided, including a network interface operable to receive a request for a service, and a processor operable to assign the request to a queue and to associate a number of resources with the queue based upon a determination of at least one dynamic parameter of the queue. Advantageously, resources may be allocated to queues in a flexible, efficient, and dynamic manner.

### TECHNICAL FIELD

The present disclosure relates generally to call centers and resource association and allocation.

### BACKGROUND

Automatic call distributors (ACDs) typically define one or more queues that distribute callers that want a particular type of service to agents who can provide that service. Agents may be associated with the queue through direct or indirect assignment. Direct assignment usually involves statically assigning one or more agents or agent groups to a queue, in which the system administrator must manually assign new agents to the queue or remove agents from the queue as dictated by demand. Indirect assignment usually involves specifying one or more configured attributes (e.g., skill and/or competency level) for both the agent and the queue, in which case the system places each agent in each of the queues for which the agent possesses all of the necessary attributes.

Typically, the indirect assignment approach allows the set of agents that belong to a queue to be changed only when the configured attributes for an agent or a queue is changed (i.e., static assignment). The indirect assignment approach does not provide a flexible way of specifying which combination(s) of attributes should be used for agent-queue assignment and also does not provide for dynamic evaluation. In one example, current systems require a call center supervisor to recognize that a change in system conditions requires more agents to answer calls and then the supervisor is required to either manually make configuration changes or to inform agents to login to overloaded queues. This process is inefficient and slow to respond to changes in call rates, which reduces the level of service provided to callers.

### OVERVIEW

In accordance with an embodiment of the present invention, an apparatus is provided, including a network interface operable to receive a request for a service, such as connection with an agent, and a processor operable to assign the request to a queue and to associate a number of resources with the queue based upon a determination of at least one dynamic parameter of the queue.

In accordance with another embodiment of the present invention, logic encoded in one or more tangible media for execution is provided, the logic when executed being operable to: receive a request for a service, assign the request to a queue, determine at least one dynamic parameter of the queue, and associate a number of resources with the queue based upon the determination of the at least one dynamic parameter.

In accordance with another embodiment of the present invention, a method is provided, including receiving a request for a service, assigning the request to a queue, determining at least one dynamic parameter of the queue, and associating a number of resources with the queue based upon the determination of the at least one dynamic parameter.

Advantageously, one embodiment of the present invention provides for flexible, efficient, and dynamic allocation of resources to queues.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example system for automatic call distribution.

FIG. 2 illustrates an example automatic call distributor in the system illustrated in FIG. 1.

FIG. 3 illustrates an example method for dynamically designating agents to a queue.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DESCRIPTION OF EXAMPLE EMBODIMENTS

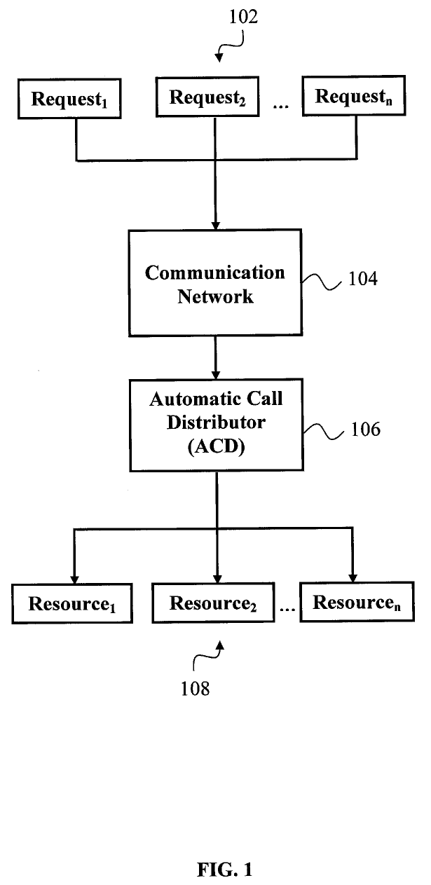

Referring to FIG. 1, an example system for automatic call distribution is illustrated. The system includes a plurality of requests 102 for a service, such as connection to a call center agent, via a communication network 104. Requests 102 may refer to service type, human callers, and/or the various communication devices used by the human callers, such as telephones and computers. Callers may initiate requests through various applicable media, including but not limited to email, instant message, chat, and fax.

Communication network 104 may include various networks such as a public switched telephone network (PSTN), an integrated services digital network (ISDN), a local area network (LAN), a wide area network (WAN), a metropolitan area network, and/or a wireless local area network (WLAN), that support standards such as Ethernet, wireless fidelity (WiFi), and/or Voice over Internet Protocol (VoIP). Other protocols for communication are also within the scope of the present invention. Communication network 104 may generally include any network capable of transmitting audio and/or video telecommunication signals, data, and/or messages, and may be implemented in any form of wireless or wireline communication network.

An automatic call distributor (ACD) 106 places the plurality of requests in queues to be handled by a plurality of resources 108 dynamically associated with the queues. Resources 108 may refer to human agents and/or the communication devices used by agents, such as telephones, headsets, and computers. Various other resources include but are not limited to an interactive voice response (IVR) port capable of speaking back information provided by customer-written logic, an Automatic Speech Recognition resource capable of understanding words spoken by the requester, a Text to Speech resource capable of speaking dynamically generated information back to the caller, a resource capable of understanding key words or phrases in the incoming test request (e.g., email, IM, chat), and logic that controls all resources and formulates a response that is sent back in the appropriate media. It is noted that the system may also use any combination of these resources to respond to a request.

In one embodiment, a user, such as a call center supervisor, is able to enter a logical expression (e.g., a Boolean expression) into ACD 106 to define a queue and/or the resources to be associated with the queue (e.g., agents to answer calls in the queue). The logical expression may include a plurality of dynamic conditions or parameters for the queue, a plurality of resource attributes or parameters, and/or a plurality of logical operators as desired. Queue dynamic parameters may include but are not limited to various real-time statistics about the agent, call, and/or system, such as average wait time in the queue, number of requests in the queue, percentage of requests handled within a service level, and age of oldest request. Other queue parameters include but are not limited to priority of the request, position of request in the queue, expected revenue from the request, age or status of customer relationship management (CRM) case associated with the request, number of resources associated with the queue in various states (e.g., logged in, ready to take a request, serving a request), time of day, day of week, time until shift change (for the case of human agents). Some of these parameters may be calculated by the ACD and others may be calculated by external applications.

Resource parameters may include but are not limited to statically configured agent parameters such as agent skills, competency levels, prior association with the caller, team or group designation, new agent status, and preference for request, and dynamic agent parameters such as status of current activity, number of requests currently being handled, performance score for a request type or a specific request, and location. Logical operators may include but are not limited to AND, OR, GREATER THAN, LESS THAN, and EQUAL TO. Examples of expressions include “A OR B”, “((A AND B) OR (A AND C))”, and “IF (A>B) THEN C ELSE D”, and so on, where A,B, and C are attributes/parameters or conditions in one example. In one embodiment, the resource parameters themselves can be statically configured or dynamically “learned” by the ACD via a variety of means. For example, a Contact Interaction Analyzer available from Cisco Systems, Inc. of San Jose, Calif., could periodically supply updated performance scores for one or more of the resources or agents.

ACD 106 may then evaluate the logical expression and dynamically associate resources with the queue based upon satisfying the logical expression in light of system conditions (e.g., determining type and number of resources to allocate to a queue). The evaluation of the logical expression may occur at configuration when the expression is created or modified, and/or dynamically in a wide variety of time frames or events, such as when a request enters or leaves the queue, an amount of time after a request enters the queue, on demand from the script controlling the request (e.g., when the requester provides a new dynamic parameter value), at a certain time of the day (e.g., agent shift change), and when various real-time statistics reach a threshold, such as the number of calls queued, and the age of the oldest call. ACD 106 may also evaluate the existing logical expression upon a change or modification of agent parameters or attributes or upon the creation and/or deletion of a new agent.

Thus, ACD 106 may dynamically adjust the set of resources that can address requests in a queue, for example making the set more or less restricted (i.e., contracting or expanding the set of resources that can answer requests in a queue) based upon dynamic system conditions. This is particularly advantageous when an event occurs that could affect desired system behavior for that queue. For example, consider a utility company that is experiencing sporadic outages. The company's contact center has queues for billing, new service activation, reporting service problems, and other areas of service. As each outage occurs, the number of calls to the service problems queue will spike. Previously, the supervisor had to detect the spike based on real-time reporting information, determine which agents who were not currently members of the queue could answer calls, and then take some action to add those agents to the queue. Advantageously, in one embodiment of the present invention, queues and agents are defined such that agents are automatically added to the queue by using dynamic parameters that reference a relevant set of dynamic system conditions, such as the number of calls in a queue and/or an average wait time. Applicable agents may then be searched and automatically allocated to the queue based upon agent parameters.

Allowing for various combinations of various attributes with logical operators provide for increased flexibility in defining a queue and/or resources to be associated with a queue. For example, consider a call center that provides support for the Microsoft Office suite of products: Word, Excel, and PowerPoint. The system may include three queues called “WordQ”, “ExcelQ”, and “PowerPointQ”. The ACD may include four skills called “WordSkill”, “ExcelSkill”, “PowerPointSkill”, and “OfficeSkill”. An agent who is a specialist in one of the products would possess the matching skill with a competency level that describes how well the agent knows that product. An agent who has a broad knowledge of the entire Office suite would possess the “OfficeSkill” with the appropriate competency level. In the system's definition of WordQ, it may be desirable to include all agents who have a certain competency level at Word as well as all agents who have a certain competency level at Office, since many Word questions could relate to features that are common across all products in the suite. Accordingly, an embodiment of the present invention allows for a logical expression for the queue to be flexibly specified, such as “WordSkill with competency of at least 5 OR OfficeSkill with competency of at least 8”.

Thus, an embodiment of the present invention allows for improved flexibility and efficiency in defining queues in an environment of multiple services and in allocating resources with multiple skills and competency levels.

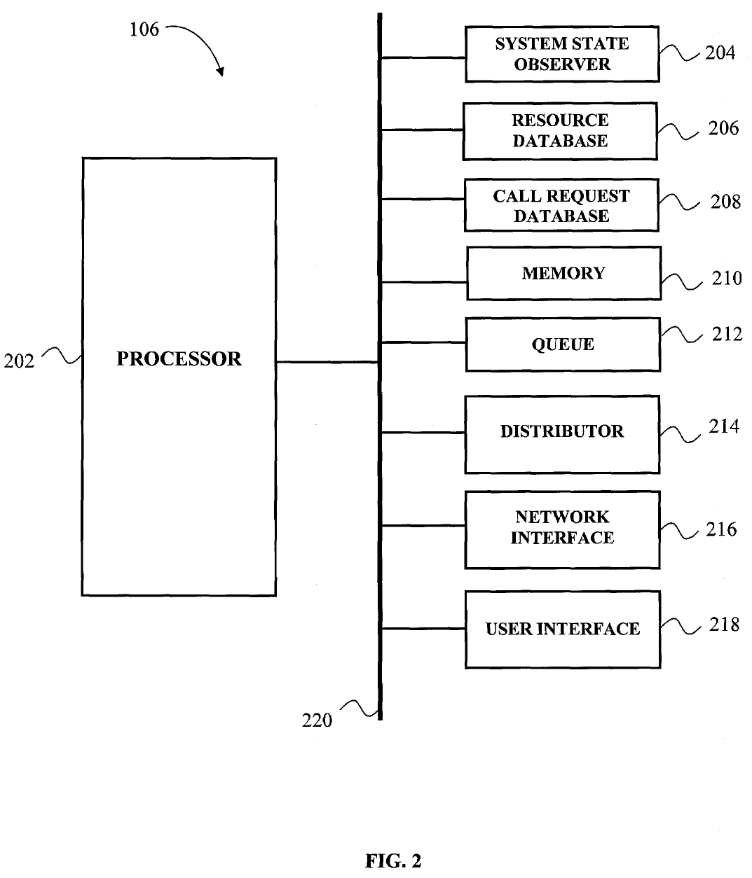

Referring now to FIG. 2 in conjunction with FIG. 1, an example of ACD 106 is illustrated. ACD 106 includes a processor 202 operably coupled via a bus 220 to the following components: a system state observer 204, a resource database 206, a call request database 208, a memory 210 (e.g., SDRAM or flash memory) via a memory interface, a queue 212, a distributor 214, a network interface 216 via an input/output port; and a user interface 218 via an input/output port. A real-time clock may also be coupled to processor 202 to be used for dynamic evaluation of logical expressions.

Processor 202 may be a microprocessor, controller, or any other suitable computing device or resource. Processor 202 may include a variety of processors (e.g., digital signal processors), conventional CPUs being applicable. When a request is received at ACD 106, processor 202 may use system state observer 204, a memory 210, databases 206 and 208, other memory modules, and other components to determine a queue and set of resources for the request.

System state observer 204 may be any combination of hardware, software, and/or encoded logic, and is used to monitor the “state” of each resource (e.g., agent availability, logged in status) and queue. Observer 204 may also monitor for and detect abandoned requests.

Resource database 206 includes data about available resources, such as agents, to be distributed among queues. Such data may include but is not limited to agent skills, competency level, prior call history, and activation date. Resource database 206 is a component that stores information in any applicable medium.

Call request database 208 includes data about past call requests, such as caller identification, agent interaction, subject matter, etc. Call request database 208 is a component that stores information in any applicable medium.

Memory 210 may include a variety of volatile or non-volatile memories, and in one example includes without limitation, magnetic media, optical media, random access memory (RAM), read-only memory (ROM), flash memory, removable media, or any other suitable local or remote memory component, or combination thereof. In one example, memory 210 may be used to store passwords, network and telecommunications programs, various protocols, and/or an operating system (OS).

Queue 212 includes pending requests from callers to be handled by a resource, such as agents or groups of agents, or an automated port, when an appropriate resource becomes available or the request is otherwise disposed of. A queue may be characterized by the user using a logical expression to define dynamic conditions that the queue must satisfy. The queue may also be characterized by the user using a logical expression to define the set of agents to be associated with the queue. It is noted that queue 212 may represent a single queue or a plurality of queues and that the system may include many instances of queue 212.

Distributor 214 connects a request from a queue with a resource (e.g., a service call to an appropriate agent) when a suitable resource is available to receive the incoming call. Processor 202 may select a resource after allocation of a set of resources to a queue and send an identifier of the selected resource to distributor 214 which completes the connection between the request and the resource.

Network interface 216 includes in one example, an adaptor for providing wired communications with a network, such as a LAN connector (e.g., a 10/100/1000 Base-T Ethernet port) via a MII interface, and/or a transmitter/receiver (transceiver) for providing wireless communications with a network and/or wireless device. A transceiver is a device that both transmits and receives/detects digital and/or analog signals, and in the context of the present invention is able to detect wireless signals from a wireless device requesting access to a network, and is further able to detect signals through a network wire and apply signals onto the network wire. Network interface 216 may communicate using any of various protocols known in the art for wireless or wired connectivity in one example.

User interface 218 is operably coupled to processor 202 and may include data input means, such as a keyboard, mouse, etc., and data display means, such as a display system. In one example, user interface 218 may include an alpha-numeric keypad and screen for entering or displaying dynamic queue parameters, agent parameters, and/or other information regarding queue or agent parameters. Other types of user interfaces, such as touch screens, are within the scope of the present invention.

A real-time clock may also be utilized to provide evaluation of the logical expression or parameters entered by the user based upon time (e.g., time, date, schedule) thereby dynamically associating agents to queues based upon dynamic system conditions.

It will be recognized by those of ordinary skill in the art that ACD 106 may include any number of processors, observers, databases, memory modules, queues, distributors, and interfaces to accomplish the functionality and features described herein. Furthermore, ACD components (e.g., processor 202, system state observer 204, databases 206, 208, and memory 210) may be centrally located with respect to one another, or distributed throughout a network.

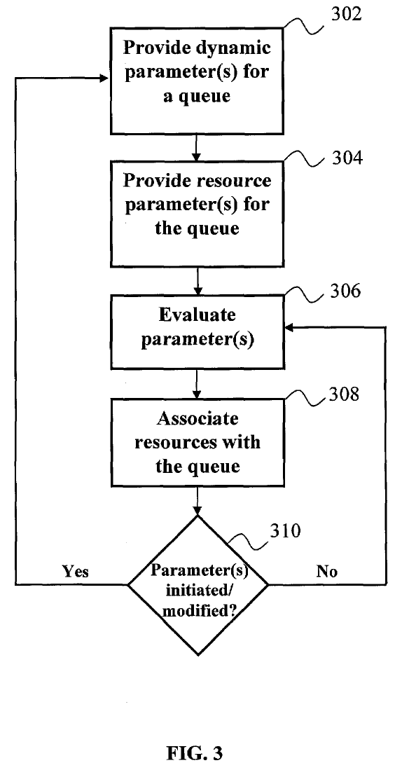

Referring now to FIG. 3 in conjunction with FIGS. 1 and 2, a flowchart of an example method of automatic resource allocation is illustrated. At a point in time, a request for a service is received by ACD 106 via a communication network and ACD 106 places the request in a queue while awaiting an available and appropriate resource. At step 302, at least one dynamic parameter for the queue is received by ACD 106, for example via user interface 218. Optionally, at step 304, resource parameters for the queue may also be received by ACD 106, for example via user interface 218. Advantageously, the dynamic parameter and resource parameter may be inputted via a logical expression including logical operators. At step 306, the dynamic parameter(s) (and resource parameters if entered) are evaluated by processor 202 which may utilize other components such as system state observer 204, resource database 206, call request database 208, memory 210, and queue 212. At step 308, ACD 106 associates/assigns resources with the queue based upon system conditions and the entered dynamic parameters or conditions. At step 310, a decision is made as to whether the parameters have been modified or initiated. If yes, the method goes back to step 302 and repeats the process to dynamically associate resources. If no, the method goes back to step 306 to evaluate the existing parameters or conditions and dynamically associate resources (e.g., expand, contract, or otherwise modify the resources associated to the queue, or keep the same).

As noted above, the decision block to evaluate parameters (and thereby dynamically associate resources) may be processed at various times. Step 302 correlates to an evaluation of a logical expression when the expression is created or modified. Step 306 correlates to an evaluation in a wide variety of time frames or events, such as when a call enters or leaves the queue, an amount of time after a call enters the queue (e.g., periodic evaluation), on demand from the script controlling the request, at a certain time of the day, and when various real-time statistics reach a threshold, such as the number of calls queued, and the age of the oldest call. ACD 106 may also evaluate the existing logical expression upon a change or modification of agent parameters or attributes or upon the creation or deletion of an agent.

Advantageously, embodiments of the present invention provide for flexible, efficient, and dynamic allocation of resources to queues. Allowing for various combinations of various attributes with logical operators provide for increased flexibility in defining or modifying a queue and associating resources to a queue. Furthermore, means for dynamic allocation of resources are provided, in which the resource pool for a queue may be dynamically checked and redefined if necessary based on a wide variety of system conditions.

Embodiments described above illustrate but do not limit the invention. It should also be understood that numerous modifications and variations are possible in accordance with the principles of the present invention. Accordingly, the scope of the invention is defined only by the following claims.

We claim:

1. An apparatus comprising:
a network interface operable to receive a request for a service; and
a processor operable to assign the request to a queue and to associate a number of resources with the queue based upon a determination of at least one dynamic parameter of the queue.

2. The apparatus of claim 1, wherein the at least one dynamic parameter is selected from the group consisting of average wait time in the queue, number of requests in the queue, percentage of requests handled within a service level, age of oldest request, priority of the request, position of request in the queue, expected revenue from the request, age or status of customer relationship management (CRM) case associated with the request, number of resources associated with the queue in various states, time of day, day of week, and time until shift change.

3. The apparatus of claim 1, wherein the at least one dynamic parameter may be inputted using a logical operator.

4. The apparatus of claim 1, wherein the processor is further operable to receive at least one agent parameter for the queue.

5. The apparatus of claim 4, wherein the at least one agent parameter is selected from the group consisting of statically configured parameters such as agent skills, competency levels, team or group designation, and preference for request, and dynamic parameters such as status of current activity, number of requests currently being handled, performance score for a request type or a specific request, and location.

6. The apparatus of claim 4, wherein the at least one agent parameter may be inputted using a logical operator.

7. The apparatus of claim 1, wherein the determination of the at least one dynamic parameter is processed at various times selected from the group consisting of receipt of the at least one dynamic parameter, when a request enters or leaves the queue, an amount of time after a request enters the queue, at a certain time of day, when a real-time statistic reaches a threshold, and when a resource is created or deleted.

8. The apparatus of claim 1, wherein the network interface is operably coupled to a communication network selected from the group consisting of a local area network, a wide area network, the Internet, a public switched telephone network (PSTN), and a metropolitan area network.

9. The apparatus of claim 1, further comprising a user interface, an agent database, and a call request database.

10. Logic encoded in one or more tangible media for execution and when executed operable to:
receive a request for a service;
assign the request to a queue;
determine at least one dynamic parameter of the queue; and
associate a number of resources with the queue based upon the determination of the at least one dynamic parameter.

11. The logic of claim 10, wherein the at least one dynamic parameter is selected from the group consisting of average wait time in the queue, number of requests in the queue, percentage of requests handled within a service level, age of oldest request, priority of the request, position of request in the queue, expected revenue from the request, age or status of customer relationship management (CRM) case associated with the request, number of resources associated with the queue in various states, time of day, day of week, and time until shift change.

12. The logic of claim 10, further operable to receive the at least one dynamic parameter including a logical operator.

13. The logic of claim 10, further operable to receive at least one agent parameter selected from the group consisting of statically configured parameters such as agent skills, competency levels, team or group designation, and preference for request, and dynamic parameters such as status of current activity, number of requests currently being handled, performance score for a request type or a specific request, and location.

14. A method comprising:
receiving a request for a service;
assigning the request to a queue;
determining at least one dynamic parameter of the queue; and
associating a number of resources with the queue based upon the determination of the at least one dynamic parameter.

15. The method of claim 14, wherein the at least one dynamic parameter is selected from the group consisting of average wait time in the queue, number of requests in the queue, percentage of requests handled within a service level, age of oldest request, priority of the request, position of request in the queue, expected revenue from the request, age or status of customer relationship management (CRM) case associated with the request, number of resources associated with the queue in various states, time of day, day of week, and time until shift change.

16. The method of claim 14, further comprising receiving the at least one dynamic parameter including at least one logical operator.

17. The method of claim 14, further comprising receiving at least one agent parameter including at least one logical operator.

18. The method of claim 17, wherein the at least one agent parameter is selected from the group consisting of statically configured parameters such as agent skills, competency levels, team or group designation, and preference for request, and dynamic parameters such as status of current activity, number of requests currently being handled, performance score for a request type or a specific request, and location.

19. The method of claim 14, further comprising changing a set of resources associated with the queue.

20. The method of claim 14, further comprising determining the at least one dynamic parameter at various times selected from the group consisting of receipt of the at least one dynamic parameter, when a request enters or leaves the queue, an amount of time after a request enters the queue, at a certain time of day, when a real-time statistic reaches a threshold, and when a resource is created or deleted.
